(19) United States
(12) Patent Application Publication
(10) Pub. No.: US 2009/0130553 A1
(43) Pub. Date: May 21, 2009

(54) Battery terminal, battery, and battery holder

(75) Inventors: Masato Nakamura, Shizuoka (JP); Yuji Tsuchida, Shizuoka (JP); Norihisa Watanabe, Aichi (JP)

Correspondence Address: HARNESS, DICKEY & PIERCE, P.L.C., P.O. BOX 828, BLOOMFIELD HILLS, MI, 48303, US

(73) Assignee: FDK ENERGY CO., LTD., Kosai-shi, Shizuoka (JP)

(21) Appl. No.: 11/990,795

(22) PCT Filed: Jul. 11, 2006
(86) PCT No.: PCT/JP2006/313762

§ 371 Date: Dec. 16, 2008

(30) Foreign Application Priority Data
Aug. 22, 2005 (JP) 2005-239521

(51) Int. Cl. H01M 2/02

(52) U.S. Cl. 429/178

(57) ABSTRACT

[Problems] A battery terminal, a battery, and a battery holder are provided which are less likely to cause a trouble that an insulated protrusion section having a configurational preventive function for improper connection is separated from a terminal surface without impairing the productivity and cost effectiveness.

[Means for Solution] In battery terminals 21 and 51 on which an insulated protrusion section 31 having a configurational preventive function for improper connection is formed by discharging ultraviolet curing resin and curing the resin, the ultraviolet curing resin contains acrylate oligomer, acrylate monomer, and photopolymerization initiator, and further contains methacrylic acid added to the resin.

### TECHNICAL FIELD

The present invention relates to a battery terminal, a battery, and a battery holder, and more particularly to those on which an insulated protrusion section having a configurational preventive function for improper connection is formed by discharging ultraviolet curing resin in the form of a spot and curing it.

### BACKGROUND ART

For example, when using a plurality of cylindrical alkaline dry batteries by connecting them in series, a battery holder (or a battery box) in which the plurality of batteries is loaded end to end is often used. In this case, an improper connection is likely to be caused due to loading some of the batteries in a reverse direction. Therefore, as shown in FIG. 6, the cylindrical alkaline dry batteries have been developed which configurationally prevents an improper connection between negative terminals 21 of batteries 10 by providing a plurality of insulated protrusion sections 31′ on each negative terminal 21 (Patent document 1).

The insulated protrusion section 31′ can be formed by discharging ultraviolet curing resin on the terminal 21 in the form of a spot and curing it. The ultraviolet curing resin is comprised of acrylate oligomer, acrylate monomer, photopolymerization initiator and the like. The insulated protrusion section 31′ having the configurational preventive function for improper connection can be formed in the form of a spot by dropping this resin on a certain position of a surface of the terminal 21 and curing it with ultraviolet irradiation. By utilizing the ultraviolet curing resin, the insulated protrusion section 31′ can be highly efficiently formed without a long-time heat treatment which potentially causes damage to the battery 10.

The battery 10 shown in FIG. 6 is an LR20 alkaline dry battery. An opening of a bottomed cylindrical metal cathode can 11, in which the power generating elements are stored, is sealed with the negative terminal 21 and a gasket. The cathode can 11 also serves as a cathode current collector and a positive terminal, and a protruded positive terminal part 12 has been formed by press-forming on an outside bottom thereof in advance. The insulated protrusion sections 31′ are formed on the surface of the negative terminal 21 so that the insulated protrusion sections configurationally prevent the improper connection between the negative terminals 21 of the batteries 10.

A plurality of insulated protrusion sections 31′ are arranged on the surface of the negative terminal 21 so that they does not block contact between the negative terminal 21 and the positive terminal part 12. It is necessary to form the insulated protrusion section 31′ in the form of a spot, preferably in a small area so that a conductive contact of the terminal 21 is not blocked when the batteries are loaded correctly. Further, it is necessary to form the insulated protrusion section 31′ highly efficiently in a manner that does not obstruct productivity and cost effectiveness. Therefore, a small amount of the ultraviolet curing resin is discharged onto the surface of the terminal 21 in the form of a spot and is cured. As a result thereof, for example, the insulated protrusion section 31′ having an external diameter of about 1.5 mm can be formed highly efficiently.

Patent document 1: Japanese Patent Application Laid-open No. 09-161762

### DISCLOSURE OF INVENTION

### Problems to be Solved by the Invention

However, the above-described insulated protrusion section 31′ does not always adhere to the negative terminal 21 stably. Troubles that the insulated protrusion section 31′ is separated from the surface of the terminal 21 frequently occurred in a step of curing the ultraviolet curing resin with ultraviolet irradiation, which is discharged onto the surface of the terminal 21, in a step of the battery assembly process after curing, in a step of loading a holder with the battery, and the like.

In order to reduce the above troubles, it is necessary to increase adhesive strength between the terminal 21 and the insulated protrusion section 31′, and the above adhesive strength heavily depends on the surface condition of a point (dropping point) where the ultraviolet curing resin has been discharged in the form of a spot.

A Ni (nickel) plated steel sheet is generally used for the negative terminal 21. An oxidation state of a surface of the plated steel sheet not only has a variation for every terminal 21 but also has a local variation depending on locations on the terminal 21. The variation of the surface condition causes a variation of the adhesive strength between the terminal 21 and the insulated protrusion section 31′. This variation is a major source which causes the troubles.

If the adhesive area is larger than a certain amount, adhering with the ultraviolet curing resin can ensure totally necessary adhesive strength even if there is any local adhesive trouble. However, the adhesive area of the above-mentioned insulated protrusion section 31′ to the terminal 21 is small, and the local adhesive trouble is likely to directly cause the section to be separated.

With regard to a manner that enhances the above adhesive strength so as to make the adhering firm, it can be considered that the surface condition of the terminal 21 is improved by, for example, polishing and the like. However, it causes a problem that the manufacturing cost of the terminal 21 becomes substantially high.

The present invention has been developed in consideration of the above problems, and an object thereof is to provide a battery terminal, a battery, and a battery holder which are less likely to cause a trouble that an insulated protrusion section having a configurational preventive function for improper connection is separated from the terminal surface without impairing the productivity and cost effectiveness.

Objects and constitutions of the present invention other than ones stated above will be apparent from the following detailed description and drawings attached herein.

### Means for Solving the Problems

According to the present invention, there are provided following means for solving the above-mentioned problems.

(1) A battery terminal, including: an insulated protrusion section that has a configurational preventive function for improper connection and that is formed on the battery terminal by discharging ultraviolet curing resin in the form of a spot and curing the resin, wherein the ultraviolet curing resin contains acrylate oligomer, acrylate monomer, and photopolymerization initiator, and further contains methacrylic acid added to the resin.
(2) A battery terminal according to the above-mentioned means (1), wherein the battery terminal is a metal terminal.
(3) A battery that is cylindrical, including: a protruded positive terminal part; and a flat negative terminal part, the negative terminal part being a battery terminal according to the above-mentioned means (1).
(4) A battery holder, including: a battery terminal according to the above-mentioned means (1) or (2).

### EFFECT OF THE INVENTION

According to the present invention, a battery terminal, a battery, and a battery holder can be provided which are less likely to cause a trouble that an insulated protrusion section having a configurational preventive function for improper connection is separated from a terminal surface without impairing the productivity and cost effectiveness.

Features/advantages other than ones stated above will be apparent from the following detailed description and drawings attached herein.

### BRIEF DESCRIPTION OF DRAWINGS

FIG. 1 is a cross-sectional view and a perspective view showing an embodiment of an alkaline dry battery to which the technology of the present invention has been applied.

FIG. 2 is a schematic cross-sectional view showing a forming condition of an insulated protrusion section, which is an essential part of the present invention.

FIG. 3 is a side view showing a condition that a plurality of alkaline dry batteries to which the technology of the present invention has been applied are loaded end to end into a battery holder.

FIG. 4 is a perspective view showing an embodiment in which the technology of the present invention is applied to a battery terminal of the battery holder side.

FIG. 5 is a side view showing an embodiment of the battery holder using the battery terminal shown in FIG. 4.

FIG. 6 is a perspective view for explaining the related art of the alkaline dry battery including a terminal having insulated protrusion sections formed thereon.

### EXPLANATION OF REFERENCE CHARACTERS

10 alkaline dry battery
11 cathode can
12 protruded positive terminal part
13 cathode mixture
14 separator
15 gelled anode mixture
21 negative terminal
22 anode current collector
23 insulating gasket
31 insulated protrusion section
50 battery holder
51 (positive) battery terminal of battery holder
52 (negative) battery terminal of battery holder

### BEST MODE FOR CARRYING OUT THE INVENTION

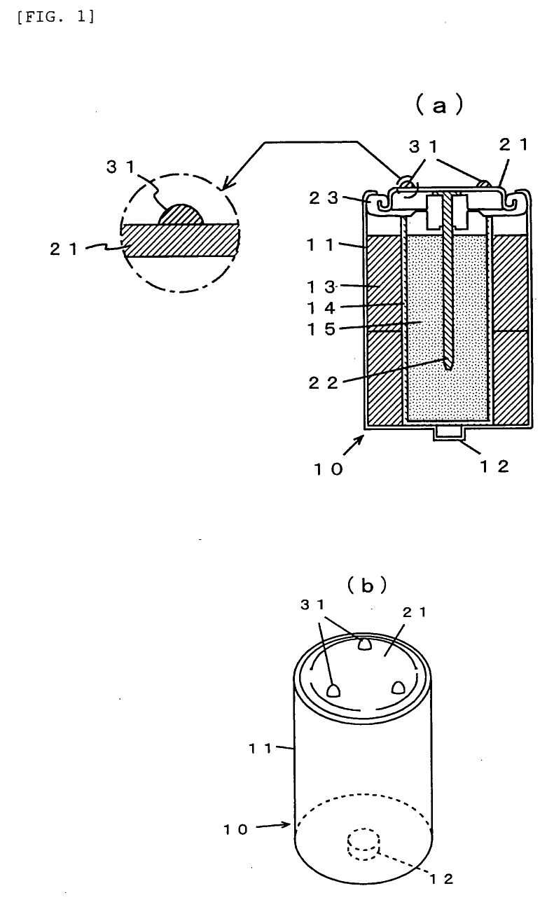

FIG. 1 shows an embodiment of an alkaline dry battery 10 to which technology of the present invention has been applied in a cross-sectional view (a) and an external perspective view (b). In the alkaline dry battery 10 shown in the above views, a cathode mixture 13, a separator 14, and a gelled anode mixture 15 are loaded into a bottomed cylindrical metal cathode can 11, and an opening of the cathode can 11 is sealed with a negative terminal 21 and an insulating gasket 23. The bottom of the above cathode can 11 forms a protruded positive terminal part 12, and the above negative terminal 21 forms a flat negative terminal surface.

The cathode can 11 is made of metal by processing a nickel-plated steel sheet into a bottomed cylindrical shape by pressing, etc., and also acts as a positive terminal. The cathode mixture 13 is an annular (or tubular) formed mixture containing oxidizing agent such as manganese dioxide or nickel oxyhydroxide and is loaded into the above cathode can 11 in a press-fit condition.

The separator 14 impregnated with an alkaline electrolyte is placed inside the cathode mixture 13, and the inside surrounded by the separator 14 is filled with the anode mixture 15 containing gelled zinc as a base compound. Further, an anode current collector 22 is inserted in the anode mixture 15. An upper end of the anode current collector 22 is connected to an inner surface of the negative terminal 21 by spot-welding and the like. The negative terminal 21 forms a sealing body of the above cathode can 11 together with a sealing material of an insulating gasket 23 and the like.

On an outer surface of the above negative terminal 21, a plurality of insulated protrusion sections 31 are placed on the periphery of a central surface of the terminal at a predetermined interval, and adhere thereto and are secured thereon. Each protrusion section 31 is a lower protrusion than the height of the protruded positive terminal part 12. The insulated protrusion sections 31 configurationally prevent an improper connection between negative terminals 21.

The negative terminal 21 is made of metal (Ni plated steel sheet) and is one embodiment of the battery terminal of the present invention. The insulated protrusion section 31 is formed nearly 1.5 mm in external diameter and nearly 0.15 mm in height by discharging (dropping) ultraviolet curing resin onto the surface of the negative terminal 21 in the form of a spot and curing it.

The curing of the resin is performed by ultraviolet irradiation without a heat treatment which potentially causes damage to the battery. The ultraviolet curing resin contains acrylate oligomer, acrylate monomer, and photopolymerization initiator, and further contains methacrylic acid added thereto.

It has been confirmed that the ultraviolet curing resin to which methacrylic acid is added is easy to enter into a minute concave portion of the surface of the terminal 21 when the resin is discharged onto the surface of the terminal 21, and increases adhesive strength with the terminal 21 so as to make the adhering firmly by improving wettability to the surface of the terminal 21.

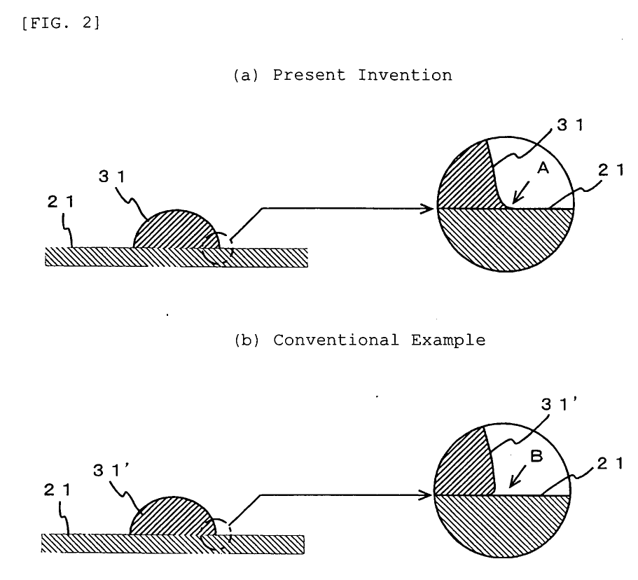

FIG. 2 shows a forming condition of the insulated protrusion section 31 in the schematic cross-sectional view. In (a) of the figure, there is shown a forming condition of the insulated protrusion section 31 formed with ultraviolet curing resin to which methacrylic acid is added. Since the insulated protrusion section 31 has good wettability to the surface of the terminal 21, this makes it less likely to cause peeling caused by shock and the like (see the arrow A in the figure). Meanwhile, in (b) in FIG. 2, there is shown a forming condition of the conventional insulated protrusion section 31′ formed with ultraviolet curing resin to which methacrylic acid is not added. Since the insulated protrusion section 31′ does not have sufficient wettability to the surface of the terminal 21, this makes it easier to cause peeling due to shock and the like (see the arrow B in the figure).

Further, in the ultraviolet curing resin to which methacrylic acid is added, although the hardness of the resin that has cured slightly falls, it has been found that this has a positive effect on enhancement of the strength and stability of adhesiveness between the insulated protrusion section 31 and the terminal 21. Particularly, in a leaf-spring type terminal, which repeatedly bends and stretches, if the resin hardness of the insulated protrusion section 31 remains high, separation will be caused by bending and stretching of the leaf spring. However, it has been found that, when the ultraviolet curing resin to which methacrylic acid is added is utilized, the hardness of the resin that has cured slightly falls, so that the separation can be certainly suppressed.

As stated above, under the particular condition that an adhesive area is small between the insulated protrusion section 31 and the terminal 21, the adhesive strength between them is not greatly affected by a surface condition of the terminal 21 and can be enhanced effectively. Thus, it is possible to reduce the occurrence of troubles that the insulated protrusion section 31 having a configurational preventive function for improper connection is separated from the surface of the terminal 21, without impairing the productivity and cost effectiveness.

FIG. 3 shows a condition that a plurality of the above alkaline dry batteries 10 are loaded end to end into a battery holder 50. The battery holder 50 is provided with a leaf-spring type terminal 51 with which the positive terminal part 12 of the battery 10 is in electrically conductive contact and a coil spring type terminal 52 with which the negative terminal 21 of the battery 10 is in electrically conductive contact.

In the figure, (a) shows a case where each battery 10 is correctly loaded into the holder 50 in a series connection. In this case, the insulated protrusion section 31 does not intervene in the series connection. The figures (b) and (c) show respective cases where a part of or all of the batteries 10 have been loaded in an improper direction. In either of the cases, the batteries 10 can be prevented from being used in an improper connection when the insulated protrusion section 31 intervenes as a kind of insulating spacer between the batteries 10 or between the battery 10 and the terminal 51 of the holder 50.

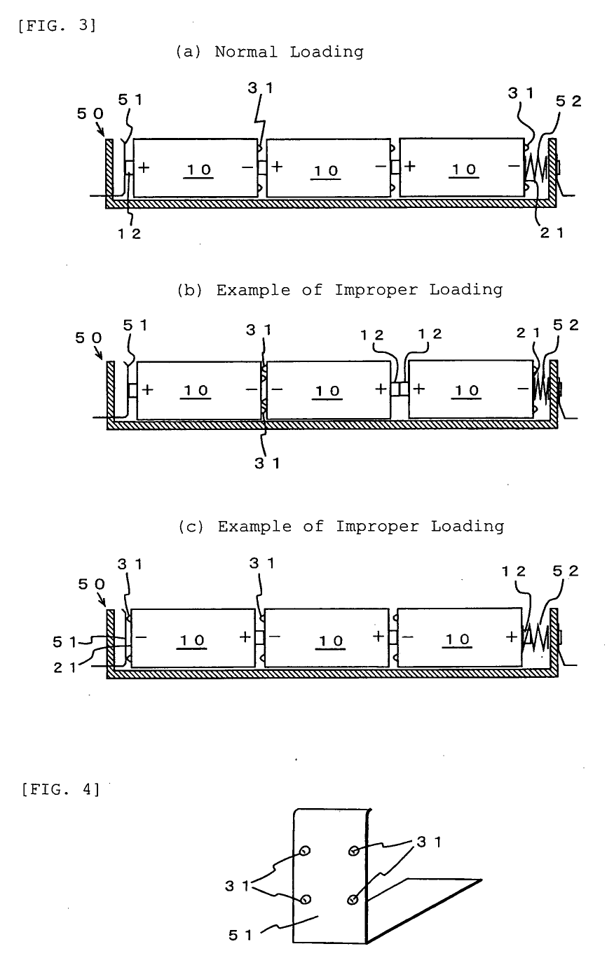

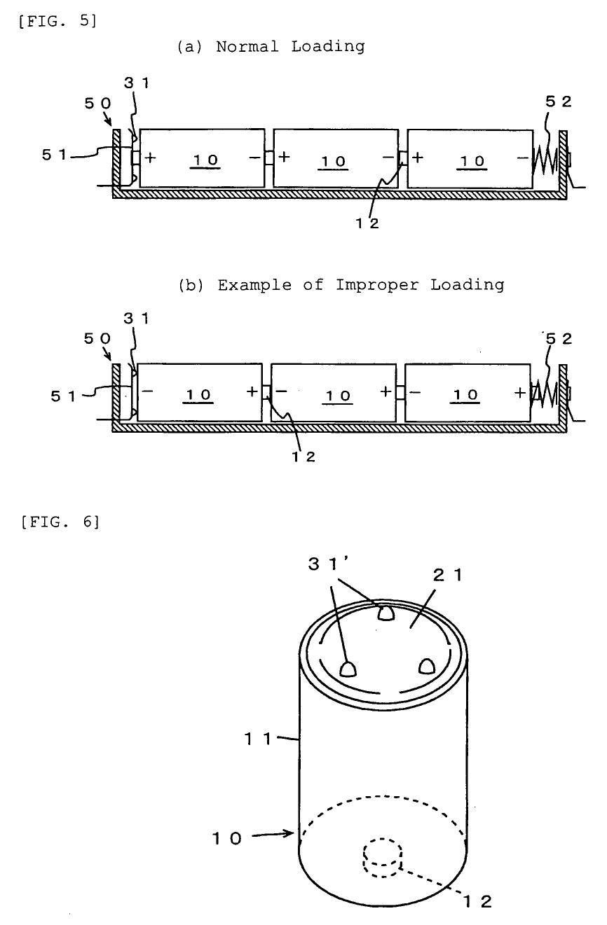

FIG. 4 shows an embodiment in which the technology of the present invention is applied to the battery terminal 51 of the battery holder side. The battery terminal 51 shown in the figure is a terminal for being in electrically conductive contact with a protruded positive terminal part of the battery. By providing the above insulated protrusion section 31 on the terminal 51, the improper connection caused by the improper loading of the batteries 10 can be prevented as shown in FIG. 5.

The above terminal 51 is a leaf-spring type one, whose spring bends and stretches (or deforms) every time the batteries 10 are loaded into and removed from the holder 50. However, even if this spring repeatedly bends and stretches, the insulated protrusion section 31 becomes less likely to separate as a result that the adhesive strength is improved and the hardness of resin that has cured is optimized by adding methacrylic acid, so that a configurational preventive function for reverse connection can be maintained stably.

FIG. 5 shows an embodiment of the battery holder 50 utilizing the battery terminal 51 of FIG. 4. In the figure, (a) shows a case where each battery 10 is correctly loaded into the holder 50 in a series connection. In this case, the insulated protrusion section 31 does not intervene in the series connection. The figure (b) shows a case where the batteries 10 have been loaded in an improper direction. In this case, the battery 10 can be prevented from being used in the improper connection as a result that the insulated protrusion section 31 intervenes as an insulating spacer between the battery 10 and the battery terminal 51.

### EXAMPLES

A plurality of types of ultraviolet curing resin having different formulation were prepared, and insulated protrusion sections having a configurational preventive function for improper connection were formed for each of the resins. For these protrusion sections, tests for adhesive strength and fraction defective caused by the separation were implemented. In addition, hardness tests of each resin that has cured were also implemented.

The test results are shown in the following Table 1. (Table 1)

TABLE 1
Test Results of Ultraviolet Curing Resin/Component/Resin
Hardness/Adhesive Strength/Fraction Defective

| | | Test 1 | | | |
|---|---|---|---|---|---|
| | | (conventional | Test 2 | Test 3 | Test 4 |
| | | item) | (Example 1) | (Example 2) | (Example 3) |
| component of | component | content | content | content | content |
| ultraviolet | | (%) | (%) | (%) | (%) |
| curing resin/ | acrylate | 35-45 | 35-45 | 35-45 | 35-45 |
| content rate | oligomer | | | | |
| | acrylate | 30-40 | 30-40 | 30-40 | 30-40 |
| | monomer | | | | |
| | diluent | 10-25 | 10-25 | 10-25 | 10-25 |
| | photopoly- | 1-10 | 1-10 | 1-10 | 1-10 |
| | merization | | | | |
| | initiator | | | | |
| | methacrylic | not | 1.1 | 0.5 | 2.5 |
| | acid | added | | | |

| | | | | |
|---|---|---|---|---|
| hardness of resin that has | 85 | 80 | 83 | 80 |
| cured (JIS-D) | | | | |
| adhesive strength | 135N | 216N | 168N | 220N |
| to Ni plated steel sheet | | | | |
| fraction defective for | 3000 ppm | 200 ppm | 1000 ppm | 200 ppm |
| peeling of insulated | | | | |
| protrusion section | | | | |

In Table 1, curing the resin was performed by irradiating ultraviolet rays of 15 Kw/m2 or more. A 24 mm diameter×5-6 mm long tablet was made by irradiating the resin injected into a mold with ultraviolet light (UV), and the hardness of the resin that has cured was measured by a type D durometer. The measurement temperature was 23±2° C.

With regard to the adhesive strength of the resin, the insulated protrusion section was formed by dropping and curing 10 mg of resin inside a hole of a stainless M4 washer which is placed on a Ni plated steel sheet. After leaving the resin until it has sufficiently cooled, the adhesive strength was measured by pushing the washer with a push-pull gauge at 50 mm/min.

As a result, as shown in Table 1, it is confirmed that the insulated protrusion section using the resin to which methacrylic acid is added substantially restrains the incidence of the separation trouble, compared to the case using the resin to which methacrylic acid is not added.

As stated above, although the present invention has been explained based on its representative embodiments, various embodiments other than those stated above can be also achieved in the present invention. For example, the terminal having an insulated protrusion section may be a terminal made of conductive materials except metal.

### INDUSTRIAL APPLICABILITY

According to the present invention, a battery terminal, a battery, and a battery holder can be provided which are less likely to cause a trouble that an insulated protrusion section having a configurational preventive function for improper connection is separated from a terminal face without impairing the productivity and cost effectiveness.

1. A battery terminal, comprising:
an insulated protrusion section that has a configurational preventive function for improper connection and that is formed on the battery terminal by discharging ultraviolet curing resin in the form of a spot and curing the resin, wherein the ultraviolet curing resin contains acrylate oligomer, acrylate monomer, and photo-polymerization initiator, and further contains methacrylic acid added to the resin.

2. A battery terminal according to claim 1, wherein
the battery terminal is a metal terminal.

3. A battery that is cylindrical, comprising:
a protruded positive terminal part; and
a flat negative terminal part, the negative terminal part being a battery terminal according to claim 1.

4. A battery holder, comprising:
a battery terminal according to claim 1 or 2.
